(19) United States
(12) Patent Application Publication
(10) Pub. No.: US 2013/0134018 A1
(43) Pub. Date: May 30, 2013

(54) MICRO-ELECTROMECHANICAL SWITCH AND A RELATED METHOD THEREOF

(71) Applicant: Marco Francesco Aimi, Niskayuna, NY (US)

(72) Inventor: Marco Francesco Aimi, Niskayuna, NY (US)

(73) Assignee: GENERAL ELECTRIC COMPANY, SCHENECTADY, NY (US)

(21) Appl. No.: 13/307,262

(22) Filed: Nov. 30, 2011

(51) Int. Cl. H01H 59/00

(52) U.S. Cl. 200/181

(57) ABSTRACT

The switch incudes a beam electrode disposed on a substrate. A beam includes at least one anchor portion coupled to the beam electrode, a first beam portion extending from the at least one anchor portion along a first direction; and a second beam portion extending from the at least one anchor portion along a second direction opposite to the first direction. A first control electrode is disposed on the substrate facing the first beam portion. A first contact electrode is disposed on the substrate facing the first beam portion. A second control electrode is disposed on the substrate facing the second beam portion. The first control electrode and the second control electrode are coupled to form a gate. A second contact electrode is disposed on the substrate facing the second beam portion.

### BACKGROUND

Micro-electromechanical systems (MEMS) devices have a wide variety of applications and are prevalent in commercial products. One type of MEMS device is a MEMS switch. A typical MEMS switch includes one or more MEMS switches arranged in an array. MEMS switches are well suited for applications including cellular telephones, wireless networks, communication systems, and radar systems. In wireless devices, MEMS switches can be used as antenna switches, mode switches, transmit/receive switches, and the like.

Typical MEMS switches use an electroplated metal cantilever supported at one end and an electrical contact arranged at the other end of the metal cantilever. A control electrode is positioned below the metal cantilever. A direct current (“DC”) actuation voltage is applied across the control electrode to the metal cantilever forcing the metal cantilever to bend downward and make electrical contact with a bottom signal trace. Once electrical contact is established, the circuit is closed and an electrical signal can pass through the metal cantilever to the bottom signal trace.

One type of MEMS device is a MEMS radio frequency (RF) switch. MEMS RF switches are used for wireless devices because of their low drive power characteristics and ability to operate in radio frequency ranges. However, a problem frequently occurs within MEMS RF switches when a significant RF voltage is applied between a beam electrode and a contact electrode. Such a voltage may couple on to the control electrode and self-actuate the switch. In other words, these MEMS switches typically suffer from a problem where the cantilever beam within the switch may actuate at the “OFF” state (self-actuation) due to the high voltage RF signal. Thus, the high voltage RF signal produces adequate electrostatic force to pull down the switch beam and cause failure.

### BRIEF DESCRIPTION

In accordance with one exemplary embodiment of the present invention, a micro-electromechanical system (MEMS) switch is disclosed. The switch incudes a beam electrode disposed on a substrate. A beam includes at least one anchor portion coupled to the beam electrode, a first beam portion extending from the at least one anchor portion along a first direction; and a second beam portion extending from the at least one anchor portion along a second direction opposite to the first direction. A first control electrode is disposed on the substrate facing the first beam portion. A first contact electrode is disposed on the substrate facing the first beam portion. A second control electrode is disposed on the substrate facing the second beam portion. The first control electrode and the second control electrode are coupled to form a gate. A second contact electrode is disposed on the substrate facing the second beam portion.

In accordance with another exemplary embodiment of the present invention, a method for operating a micro-electromechanical system (MEMS) switch is disclosed. The method includes applying an actuation voltage between a gate and a beam electrode to apply the actuation voltage equally to a control electrode and a second control electrode. The first control electrode, the second control electrode, and the beam electrode are disposed on a substrate. The first control electrode and the second control electrode are coupled to form a gate. The method further includes biasing a first beam portion and a second beam portion of a beam from a first position to a second position such that a first beam contact portion of the first beam portion and a second beam contact portion of the second beam portion contacts the first contact electrode and the second contact electrode respectively disposed on the substrate. The beam includes an anchor portion coupled to the beam electrode. The first beam portion extends from the anchor portion along a first direction. The second beam portion extends from the anchor portion along a second direction opposite to the first direction.

### DRAWINGS

These and other features and aspects of embodiments of the present invention will become better understood when the following detailed description is read with reference to the accompanying drawings in which like characters represent like parts throughout the drawings, wherein:

FIG. 1 is a diagrammatical representation of a micro-electromechanical system (MEMS) device for decoupling one or more surface coils of a coil system in accordance with an exemplary embodiment of the present invention;

FIG. 2 is a sectional view of a MEMS device having a MEMS switch system in accordance with an exemplary embodiment of the present invention;

FIG. 3 is a diagrammatical representation of a MEMS switch in accordance with an embodiment of FIG. 2; and

FIG. 4 is a diagrammatical representation of a MEMS switch in accordance with an embodiment of FIG. 2.

### DETAILED DESCRIPTION

In accordance with the embodiments of the present invention, a micro-electromechanical system (MEMS) switch is disclosed. The MEMS switch includes a beam electrode disposed on a substrate. A beam includes an anchor portion coupled to the beam electrode. A first beam portion extends from the anchor portion along a first direction; and a second beam portion extends from the anchor portion along a second direction opposite to the first direction. A first control electrode and a first contact electrode are disposed on the substrate facing the first beam portion. A second control electrode and a second contact electrode are disposed on the substrate facing the second beam portion. In accordance with certain specific embodiments, a method for operating a MEMS switch is disclosed.

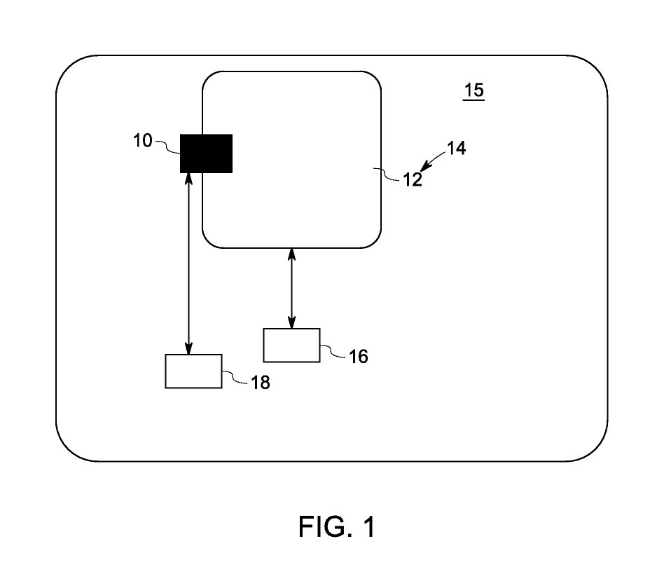

Referring to FIG. 1, a micro-electromechanical system (MEMS) device 10 for decoupling one or more surface coils 12 of a coil system 14 in a radio frequency (RF) device 15, for example, a magnetic resonance imaging (MRI) system, is disclosed. It should be noted herein that although a MRI system is disclosed, in other embodiments, the MEMS device 10 may be used for other applications. For example, in another embodiment, the device 15 may be a radar system. In the illustrated embodiment, the MEMS device 10, allows switching to isolate one or more surface coils 12, particularly radio-frequency (RF) magnetic resonance coils. In one embodiment, during a MRI transmit operation, the MEMS device 10 is operable to decouple the surface coils 12 configured as receive surface coils. In one embodiment, the MEMS device 10 is in an open state during a transmit operation to decouple the surface coil 12 (a receive RF coil) from the coil system 14. The MEMS device 10 is in a closed state during a receive operation such that the surface coil 12 resonates and couples with the received MR signals such that the received MR signals are transmitted to an RF receiver 16. The MEMS device 10 is controlled by a switch controller 18 that switches the MEMS device 10 from the open state to the closed state, and vice versa. In some embodiments, the MEMS device 10 is in a normally open state (decoupled state) when the coil system 14 is not biased. However, in other embodiments, the MEMS device 10 is in a normally closed state when the coil system 14 is not biased.

It should be noted herein that in other embodiments, the MEMS device 10 may be used in connection with different types of magnetic resonance surface coils (also referred to herein as “surface coils”) operating at different frequencies. The surface coils may be single frequency or dual-frequency (doubly-tuned) RF coils. The dual-frequency RF coils in some embodiments include concentric coil elements that are tuned to resonate at different frequencies, for example, one resonant for carbon and one resonant for proton, namely to resonate at the Larmor frequencies of carbon and proton to induce Larmor precession in the carbon atoms and protons. It should be noted that the MEMS device 10 is not limited to coupling only to receive surface coils. For example, the MEMS device 10 may be coupled to a transmit only coil or a combination of the transmit/receive coil.

Various embodiments of the MEMS device 10 may be provided as part of a single modality or multi-modality magnetic resonance imaging system. The MRI system may be combined with different types of medical imaging systems, such as a Computed Tomography (CT), Positron Emission Tomography (PET), a Single Photon Emission Computed Tomography (SPECT), as well as an ultrasound system, or any other system capable of generating images, particularly of a human. Moreover, the various embodiments are not limited to medical imaging systems for imaging human subjects, but may include veterinary or non-medical systems for imaging non-human objects, luggage, etc.

The MEMS device 10 may be coupled to one or more surface coils 12, for example, one or more receive surface coils. In one embodiment, a single MEMS device 10 may be coupled to each surface coil 12. In another embodiment, a single MEMS device 10 may be coupled to a plurality of surface coils 12. In a specific embodiment, a separate MEMS device 10 may be coupled to each of the surface coils 12. Additionally, the MEMS device 10 may be configured to decouple all of the surface coils 12 or selected ones of the surface coils 12. Although the surface coils 12 may be illustrated in a particular arrangement, such as with an inner coil element and an outer element forming a pair of loop coils (dual-frequency or doubly-tuned RF coil element), the MEMS device 10 may be used to control decoupling of any type of MRI coil, particularly, any type of magnetic resonance receive surface coil or transmit surface coil. It should be noted that the MEMS device 10 is not limited to coupling only to receive surface coils. In one embodiment, the MEMS device 10 may be coupled to a transmit only coil or a combination transmit/receive coil.

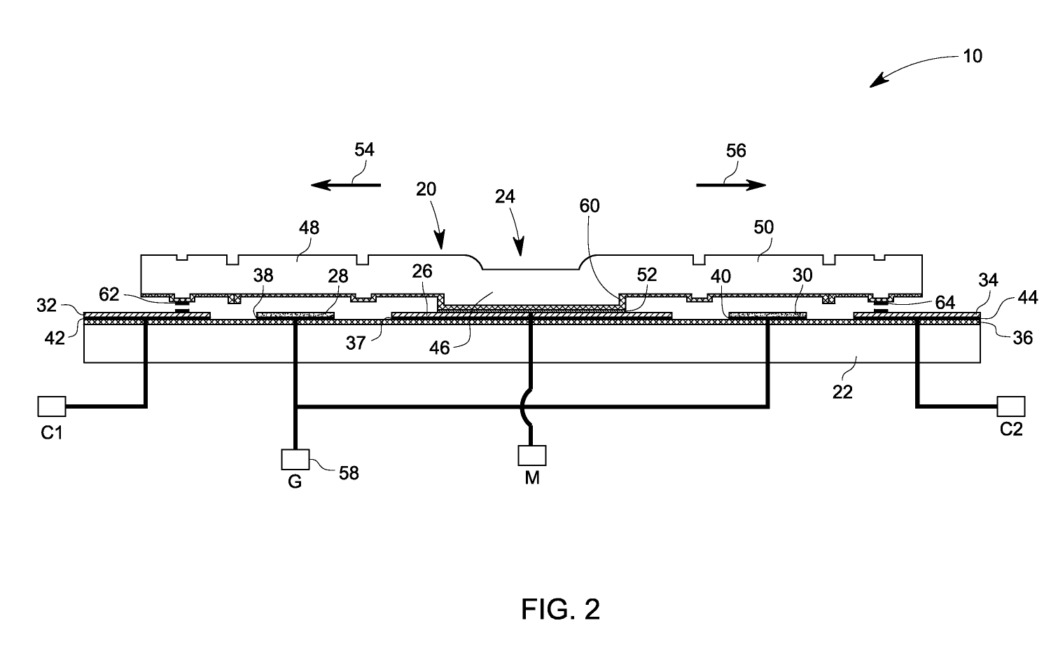

Referring to FIG. 2, the MEMS device 10 is shown. In the illustrated embodiment, the MEMS device 10 includes a MEMS switch 20. The MEMS device 10 includes a substrate 22, a beam 24, a beam electrode 26, first and second control electrodes 28, 30, and first and second contact electrodes 32, 34. In some embodiments, more than one substrate may be used. This back-to-back configuration can be instantiated either one substrate or multiple substrates.

In the illustrated embodiment, a first intermediate layer 36 is disposed on the substrate 22. The first control electrode 28 is disposed on the first intermediate layer 36 via a second intermediate layer 38. The second control electrode 30 is disposed on the first intermediate layer 36 via a third intermediate layer 40. The first contact electrode 32 is disposed on the first intermediate layer 36 via a fourth intermediate layer 42. The second contact electrode 34 is disposed on the first intermediate layer 36 via a fifth intermediate layer 44. The beam electrode 26 is disposed on the on the first intermediate layer 36 via a sixth intermediate layer 37. It should be noted herein that number of intermediate layers may vary depending upon the application.

The beam 24 includes an anchor portion 46, a first beam portion 48, and a second beam portion 50. In some embodiments, the beam 24 may include more than one anchor portion, where the anchor portions are mutually coupled electrically. In the illustrated embodiment, the anchor portion 46 is coupled to the beam electrode 26 via a seventh intermediate layer 52. The first beam portion 48 extends from the anchor portion 46 along a first direction 54 and the second beam portion 50 extends from the anchor portion 46 along a second direction 56 opposite to the first direction 54. The first control electrode 28 and the first contact electrode 32 are disposed facing the first beam portion 48. The second control electrode 30 and the second contact electrode 34 are disposed facing the second beam portion 50. In the illustrated embodiment, the first control electrode 28 and the second control electrode 30 are coupled to form a gate 58. The gate 58 is any type of voltage source, for example, a square wave voltage source capable of driving or biasing the MEMS switches 20 to cause the beam 24 in the MEMS switch 20 to bend or deflect such that an electrical path is provided through the MEMS switch 20 (i.e., a closed state of the MEMS switch 20). A seed layer 60 is formed on the beam 24 facing the beam electrode 26, the first and second control electrodes 28, 30, the first and second contact electrodes 32, 34, and the first intermediate layer 36.

The beam 24 may be formed from different materials. For example, the beam 24 may be formed from one or more different metals, such as gold, gold alloy, nickel, nickel alloy, tungsten, or the like. The substrate 22 may include silicon, silica, quartz, or the like and the intermediate layers may include silicon nitride, silicon oxide, adhesion layers, or the like. The electrodes 26, 28, 30, 32, 34 may include metals such as gold, platinum, tantalum, or the like. In a specific embodiment, the electrodes 26, 28, 30, 32, 34 may include metal oxides. It should be noted herein that the composition of the beam 24, substrate 22, and electrodes 26, 28, 30, 32, 34 disclosed herein are not all inclusive and may vary depending upon the application. The MEMS switch 20 may be manufactured using technique involving deposition, anodization, patterning, etching, or the like.

The dimensions of the beam 24 may be varied, for example, based on particular bending or deflecting requirements, such as how much force is needed to bend or deflect the beam 24. The dimensions and configuration of the beam 24 also may be based on the voltage applied between the gate 58 and the beam electrode 26 used to deflect the beam 24. The dimensions and configuration of the beam 24 also may be based on the voltage of the gate 58 used to deflect the beam 24. It should be noted herein that the MEMS switch 20 may be formed from different materials and using different processes, for example, based on the particular application for the MEMS device 20 (e.g., MRI system application) to ensure that the device operates properly in a particular environment without affecting the environment.

In some embodiments, the MEMS device 10 may include a plurality of MEMS switches 20 that operate in either an open or closed state based on, for example, whether the imaging system (e.g., MRI system) is in a transmit or receive mode, respectively, when coupled to the surface coil. In some embodiments, the MEMS switches 20 may be coupled in series to form a group. In certain embodiments, a set or group of MEMS switches 20 may be coupled parallel to each other.

When no actuation voltage is applied between the gate 58 and the beam electrode 26, the first beam portion 48 and the second beam portion 50 are disposed at a first position in such a way that a first beam contact portion 62 of the first beam portion 48 and a second beam contact portion 64 of the second beam portion 50 are spaced apart from the first contact electrode 32 and the second contact electrode 34 respectively, referred to as an “open state”. When an actuation voltage is applied between the gate 58 and the beam electrode 26, the first beam portion 48 and the second beam portion 50 are biased from the first position to a second position in such a way that the first beam contact portion 62 and the second beam contact portion 64 contacts the first contact electrode 32 and the second contact electrode 34 respectively allowing the current to flow from the first and second beam contact portions 62, 64 to the first and second contact electrodes 32, 34, referred to as a “closed state”.

As discussed previously, MEMS RF switches are used for wireless devices because of their low power characteristics and ability to operate in radio frequency ranges. However, if a conventional three-terminal MEMS switch is provided into an RF blocking path, a voltage is generated between a contact electrode and a control electrode in the open state of the switch. This voltage is generated because the capacitance between the contact electrode and the beam electrode is of the same order as the capacitance between the contact electrode and the control electrode. This voltage may not be fine, if the switch is blocking a relatively low voltage compared to a gating voltage of the switch. However, when the RF voltage between the contact electrode and the beam electrode increases, more voltage will be generated across the control electrode that increases the risk of self-actuation of the switch that leads to damage of the MEMS switch.

In accordance with the embodiments of the present invention, two control electrodes, namely the first control electrode 28 and the second control electrode 30 are coupled to form a gate 58. The first control electrode 28 and the second control electrode 30 are configured in such a way that when an actuation voltage is applied between the gate 58 and the beam electrode 26, the actuation voltage is applied equally to the first control electrode 28 and the second control electrode 30. This allows actuation of the first beam portion 48 and the second beam portion 50 using the same gating signal.

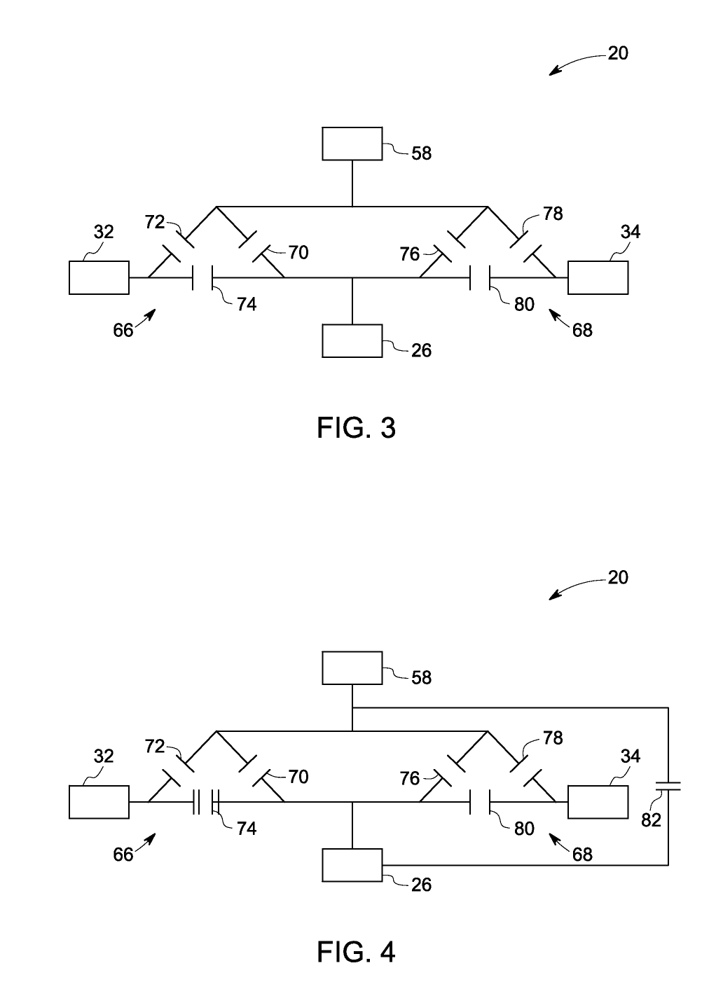

Referring to FIG. 3, the MEMS switch 20 including a back-to-back orientation in accordance with an embodiment of FIG. 2 is illustrated. In the illustrated embodiment, the MEMS switch 20 has a symmetrical arrangement modeled as two triangles 66, 68, each triangle having three capacitors, coupled to the contact electrodes 32, 34. The triangle 66 has a first capacitor 70 indicative of a capacitance between the gate 58 and the first beam portion 48, a second capacitor 72 indicative of capacitance between the gate 58 and the first contact electrode 32, and a third capacitor 74 indicative of capacitance between the first beam portion 48 and the first contact electrode 32. The triangle 68 has a fourth capacitor 76 indicative of a capacitance between the gate 58 and the second beam portion 50, a fifth capacitor 78 indicative of a capacitance between the gate 58 and the second contact electrode 34, and a sixth capacitor 80 indicative of a capacitance between the second beam portion 50 and the second contact electrode 34.

Referring to FIG. 4, the MEMS switch 20 include a back-to-back orientation in accordance with an embodiment of FIG. 2. In the illustrated embodiment, the MEMS switch 20 has a similar arrangement as shown in FIG. 3. Additionally, the switch 20 is modeled as having a capacitor 82 indicative of a capacitance between the gate 58 and the beam electrode 26.

As discussed above, radio frequency signal blocking is performed when the MEMS switch 20 is in an open state with the first and second beam portions 48, 50 being separated from the first and second contact electrodes 32, 34 respectively. The voltage which is generated across the MEMS switch 20, includes high frequency signals, which causes capacitive coupling across each of the capacitances across the MEMS switch 20. As a result, in such a configuration, the voltage at the beam electrode 26 is equal to half the voltage across the first and second contact electrodes 32, 34. The voltage at the gate 58 is also equal to half the voltage across the first and second contact electrodes 32, 34 provided the capacitances are equal. As a result of such a configuration, self-actuation of the switch 20 is prevented.

The back-to-back configuration of the MEMS switch 20 allows for electrical communication between the two control electrodes 28, 30 (shown in FIG. 2). In one embodiment, this electrical communication is done via a resistor, and in other embodiments, this electrical communication is done passively via capacitors and/or inductors. In certain other embodiments, the electrical communication is done actively using a control logic. This electrical communication results in the same voltage at both the control electrodes, and the voltage at the gate is same as the voltage at the beam. Under conditions where the capacitances across the switch 20 are equal, a voltage generated between the beam electrode and gate is near zero even in presence of substantially higher radio frequency signals. The exemplary MEMS switch 20 has a stand-off voltage that is greater than 300 volts so as to prevent self-actuation of the switch 20 when the MEMS switch 20 is in an open state.

In accordance with certain embodiments of the present invention, a capacitance between the first beam portion and the first contact electrode, and between the second beam portion and the second contact electrode is the same. In some embodiments, a capacitance between the first contact electrode and first control electrode, and between the second contact electrode and the second control electrode is the same. In a specific embodiment, a capacitance between the beam and the gate is greater than at least twice a capacitance between the first control electrode and the first contact electrode.

The symmetry of the back-to-back configuration of the switch 20 is based on a layout, a process variability, and assembly configuration of the switch. One or more elements added to the switch may generate an asymmetrical configuration, causing residual voltage to be generated between the gate and the beam electrode of the switch. In one embodiment, this residual voltage can be mitigated passively using a capacitor between the gate and beam electrode. In another embodiment, the residual voltage can be mitigated actively using a control logic. As discussed previously, the exemplary switch may include one or more substrates.

It should be noted herein that life of the MEMS switch may be based on an amount of residual voltage generated across the contact electrodes, when the MEMS switch is in a close state. Such a voltage may be typically referred to as a “hot switch voltage”. In applications, where the RF voltage is removed before actuating the switch, there is potential for residual low frequency or DC voltage to still remain across the switch due to the low open state capacitance and low leakage current. In accordance with an embodiment of the present invention, such an effect is mitigated by allowing electrical communication between the contact electrodes and the beam electrode in the switch. This electrical communication can be done via passive components such as resistors, inductors, diodes or via active control logic. Such electrical communication allows for low frequency components of signal to pass through the open switch while maintaining the required high frequency blocking.

In some embodiments, the life of the MEMS switch 20 may be enhanced by providing the plurality of capacitors in series with the first and second contact electrodes 32, 34 of the switch 20. These capacitors facilitate to minimize both the hot switch voltage and a hot switch energy (i.e. total charge transfered upon closure of the switch). This implementation is particularly advantageous when the switch 20 is isolated from the influence of gate control logic.

In some embodiments, an array of back-to-back configuration of exemplary switches 20 are envisaged. In such embodiments, a single gate 58 is used to actuate array of switches 20 in series allowing for a doubling of the gate voltage without increasing the need for extra gates. The number of MEMS switches 20 may be varied depending on the particular application, for example, the environment in which the MEMS switch 20 is operating. For example, in a magnetic environment or an RF environment, the number of MEMS switch 20 may be determined based on the voltage pulse effect, such that a standoff voltage is overcome. In particular, based on an RF standoff voltage, a number and configuration of MEMS switches 20 may be varied such that self-actuation from the RF signals is prevented.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A micro-electromechanical system (MEMS) switch, comprising:
a substrate;
a beam electrode disposed on the substrate;
a beam comprising at least one anchor portion coupled to the beam electrode, a first beam portion extending from the at least one anchor portion along a first direction; and a second beam portion extending from the at least one anchor portion along a second direction opposite to the first direction;
a first control electrode disposed on the substrate facing the first beam portion;
a first contact electrode disposed on the substrate facing the first beam portion;
a second control electrode disposed on the substrate facing the second beam portion; wherein the first control electrode and the second control electrode are coupled to form a gate; and
a second contact electrode disposed on the substrate facing the second beam portion.

2. The MEMS switch of claim 1, wherein the first beam portion comprises a first beam contact portion.

3. The MEMS switch of claim 2, wherein the second beam portion comprises a second beam contact portion.

4. The MEMS switch of claim 3, wherein the first beam portion and the second beam portion are disposed at a first position such that the first beam contact portion and the second beam contact portion are spaced apart from the first contact electrode and the second contact electrode respectively, when an actuation voltage is not applied between the gate and the beam electrode.

5. The MEMS switch of claim 4, wherein the first beam portion and the second beam portion are biased from the first position to a second position such that the first beam contact portion and the second beam contact portion contacts the first contact electrode and the second contact electrode respectively, when the actuation voltage is applied between the gate and the beam electrode.

6. The MEMS switch of claim 1, wherein the first control electrode and the second control electrode are configured to apply the control voltage equally to the first control electrode and the second control electrode.

7. The MEMS switch of claim 1, wherein the MEMS switch has a stand-off voltage that is greater than 300 volts when the MEMS switch is in an open state.

8. The MEMS switch of claim 1, where a capacitance between the first beam portion and the first contact electrode, and between the second beam portion and the second contact electrode is the same.

9. The MEMS switch of claim 1, wherein a capacitance between the first contact electrode and first control electrode, and between the second contact electrode and the second control electrode is the same.

10. The MEMS switch of claim 1, where a capacitance between the beam and the gate is greater than at least twice a capacitance between the first control electrode and the first contact electrode.

11. The MEMS switch of claim 1, further comprising a plurality of capacitors to at least one of the first contact electrode, the second contact electrode.

12. The MEMS switch of claim 1, wherein the MEMS switch comprises a MEMS radio frequency switch.

13. The MEMS switch of claim 1, wherein the MEMS switch is disposed in a device configured to operate in a radio frequency range.

14. The MEMS switch of claim 13, wherein the device comprises a magnetic resonance imaging system comprising a single modality imaging system or a multi-modality imaging system.

15. The MEMS switch of claim 14, wherein the MEMS switch is arranged to couple and decouple one or more radio frequency receive surface coils, radio frequency transmit surface coils of the magnetic resonance imaging system.

16. The MEMS switch of claim 15, wherein the one or more radio frequency receive surface coils, and radio frequency transmit surface coils comprise one of one or more single frequency coils, or one or more dual-frequency coils.

17. A method for operating a micro-electromechanical system (MEMS) switch, comprising:
applying an actuation voltage between a gate and a beam electrode to apply the actuation voltage equally to a control electrode and a second control electrode; wherein the first control electrode, the second control electrode, and the beam electrode are disposed on a substrate; wherein the first control electrode and the second control electrode are coupled to form a gate;
biasing a first beam portion and a second beam portion of a beam from a first position to a second position such that a first beam contact portion of the first beam portion and a second beam contact portion of the second beam portion contacts the first contact electrode and the second contact electrode respectively disposed on the substrate; wherein the beam comprises an anchor portion coupled to the beam electrode, wherein the first beam portion extend from the anchor portion along a first direction; and the second beam portion extend from the anchor portion along a second direction opposite to the first direction.

18. The method of claim 17, comprising disposing the first beam portion and the second beam portion at the first position such that the first beam contact portion and the second beam contact portion are spaced apart from the first contact electrode and the second contact electrode respectively, when the actuation voltage is not applied between the gate, and the beam electrode.

19. The method of claim 17, further comprising preventing self-actuation of the MEMS switch when the MEMS switch is in an open state.
